(19) United States
(12) Patent Application Publication
(10) Pub. No.: US 2014/0024129 A1
(43) Pub. Date: Jan. 23, 2014

(54) Systems and Methods for Measuring Total Sulfur Content in a Fluid Stream

(71) Applicants: Shirley Ann Meyer, Friendswood, TX (US); Randy James Meyer, Friendswood, TX (US); Stevie Horton Smith, Seabrook, TX (US)

(72) Inventors: Shirley Ann Meyer, Friendswood, TX (US); Randy James Meyer, Friendswood, TX (US); Stevie Horton Smith, Seabrook, TX (US)

(73) Assignee: CAMERON INTERNATIONAL CORPORATION, Houston, TX (US)

(21) Appl. No.: 13/554,703

(22) Filed: Jul. 20, 2012

(51) Int. Cl. G01N 30/06

(52) U.S. Cl. CPC G01N 30/06
USPC 436/123; 422/89

(57) ABSTRACT

A system for determining the content of sulfur in a first fluid mixture includes a gas chromatograph including a sample valve, a first column coupled to the sample valve, and a second column coupled to the sample valve. In addition, the system includes a pyrolizer configured to subject the first fluid mixture to pyrolysis to produce a second fluid mixture that includes hydrogen sulfide. The first column is configured to separate at least a first constituent of the second fluid mixture from the hydrogen sulfide in the second fluid mixture and output a third fluid mixture including the hydrogen sulfide. The second column is configured to separate at least a second constituent in the third fluid mixture from the hydrogen sulfide in the third fluid mixture and output a fourth fluid mixture including the hydrogen sulfide. Further, the system includes a detector in fluid communication with the second column.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field of the Invention

The invention relates generally to systems and methods for measuring the total sulfur content in a fluid stream. More particularly, the invention relates to systems and methods for measuring the total sulfur content in a process stream, such as a flare or fuel gas stream, that includes one or more sulfur compounds.

2. Background of the Technology

Sulfur emissions are gasses released into the atmosphere by power plants, oil refineries, chemical plants, factories and motor vehicles, to name but a few sources. Hydrocarbons typically contain sulfur, and, thus, the burning and processing of hydrocarbons often results in the emission of sulfur compounds. In the environment, sulfur compounds oxidize to form sulfur dioxide (SO₂), a noxious gas that is an environmental pollutant and that can cause respiratory damage, vision impairment (in sufficient concentrations), and acid rain. Accordingly, the requirement to measure for either specific sulfur species, such as hydrogen sulfide (H₂S), or total sulfur content (ppm) is becoming increasingly common in environmental regulations. For instance, current environmental mandates require refineries and chemical plants to measure the total sulfur content (ppm) in flare gas.

Specific sulfur species and total sulfur are conventionally measured with a stand-alone analyzer that may employ a gas chromatograph with a flame photometric or chemiluminescence detector, or simply a stand-alone detector such as lead acetate tape, colorimetric techniques, pulsed ultraviolet fluorescence in combination with oxidation of sulfur compounds, or energy dispersive X-ray fluorescence. However, such conventional analyzers are relatively expensive and difficult to maintain. Further, such analyzers work to varying degrees, may be limited to the measurement of select sulfur species, and may have accuracy or reliability issues. For example, some conventional analyzers may provide inaccurate measurements due to interference and interaction with non-sulfur containing chemical species.

Accordingly, there remains a need in the art for systems and methods for measuring the total sulfur content in a fluid stream, such as a flare or fuel gas stream, containing sulfur compounds. Such systems and methods would be particularly well-received if they offered the potential to be relatively low cost, reliable, and accurate.

### BRIEF SUMMARY OF THE DISCLOSURE

These and other needs in the art are addressed in one embodiment by a system for determining the content of sulfur in a first fluid mixture including one or more sulfur compounds. In an embodiment, the system comprises a gas chromatograph including a sample valve configured to receive the first gas mixture, a first column coupled to the sample valve, and a second column coupled to the sample valve. In addition, the system comprises a pyrolizer coupled to the sample valve. The pyrolizer is configured to subject the first fluid mixture to pyrolysis to produce a second fluid mixture that includes hydrogen sulfide. The first column is configured to receive the second fluid mixture from the pyrolizer and separate at least a first constituent of the second fluid mixture from the hydrogen sulfide in the second fluid mixture and output a third fluid mixture including the hydrogen sulfide. The second column is configured to receive the third fluid mixture from the first column and separate at least a second constituent in the third fluid mixture from the hydrogen sulfide in the third fluid mixture and output a fourth fluid mixture including the hydrogen sulfide. Further, the system comprises a detector in fluid communication with the second column. The detector is configured to receive the fourth fluid mixture from the second column and determine the content of hydrogen sulfide in the fourth fluid mixture.

These and other needs in the art are addressed in another embodiment by a method for determining the content of sulfur in a gas mixture including hydrocarbons and sulfur compounds. In an embodiment, the method comprises (a) acquiring a sample of the gas mixture. In addition, the method comprises (b) subjecting the sample to pyrolysis in a pyrolizer. Further, the method comprises (c) converting the sulfur compounds to hydrogen sulfide during (b). Still further, the method comprises (d) separating high-weight hydrocarbons from the hydrogen sulfide with a first column of a gas chromatograph after (b). Moreover, the method comprises (e) flowing the hydrogen sulfide to a detector after (d). The method also comprises (f) determining the hydrogen sulfide content with the detector.

These and other needs in the art are addressed in another embodiment by a system for determining the content of sulfur in a fluid mixture including one or more sulfur compounds. In an embodiment, the system comprises a gas chromatograph including a sample valve, a first column coupled to the sample valve, and a second column coupled to the sample valve. In addition, the system comprises a pyrolizer coupled to the sample valve. Further, the system comprises a hydrogen sulfide detector in fluid communication with the second column.

These and other needs in the art are addressed in another embodiment by a method for determining the content of sulfur in flare gas including hydrocarbons and sulfur compounds. In an embodiment, the method comprises (a) periodically acquiring a sample of flare gas, wherein each sample has a volume of 0.5-5.0 cc. In addition, the method comprises (b) converting the sulfur compounds in each sample to hydrogen sulfide. Further, the method comprises (c) separating the hydrocarbons from the hydrogen sulfide in each sample. Still further, the method comprises (d) determining the hydrogen sulfide content in each sample with a detector after (c).

Embodiments described herein comprise a combination of features and advantages intended to address various shortcomings associated with certain prior devices, systems, and methods. The various characteristics described above, as well as other features, will be readily apparent to those skilled in the art upon reading the following detailed description, and by referring to the accompanying drawings.

### BRIEF DESCRIPTION OF THE DRAWINGS

For a detailed description of the preferred embodiments of the invention, reference will now be made to the accompanying drawings in which:

FIG. 1 is a schematic view of an embodiment of a system for measuring the total sulfur content in a sample of fluid containing sulfur compounds;

FIG. 2 is a cross-sectional view of the flow tube and heating element of the pyrolizer of FIG. 1;

FIG. 3A is a schematic view of the system of FIG. 1 with the sample valve in a closed or backflush mode;

FIG. 3B is a schematic view of the system of FIG. 1 with the sample valve in an open or sampling mode;

FIG. 4 is a graphical illustration of an embodiment of a method for measuring the total sulfur content in a sample of flare gas with the system of FIG. 1; and

FIG. 5 is a schematic view of an embodiment of a system for measuring the total sulfur content in a sample of fluid containing sulfur compounds.

### DETAILED DESCRIPTION OF THE PREFERRED EMBODIMENTS

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawings are not necessarily to scale. Certain features and components herein may be shown exaggerated in scale or in somewhat schematic form, and some details of conventional elements may not be shown in interest of clarity and conciseness.

In the following discussion and in the claims, the terms “including” and “comprising” are used in an open-ended fashion and, thus, should be interpreted to mean “including, but not limited to . . . .” Also, the term “couple” or “couples” is intended to mean either an indirect or direct connection. Thus, if a first device couples to a second device, that connection may be through a direct connection, or through an indirect connection via other devices, components, and connections. In addition, as used herein, the terms “axial” and “axially” generally mean along or parallel to a central axis (e.g., central axis of a body or a port), while the terms “radial” and “radially” generally mean perpendicular to the central axis. For instance, an axial distance refers to a distance measured along or parallel to the central axis, and a radial distance means a distance measured perpendicular to the central axis.

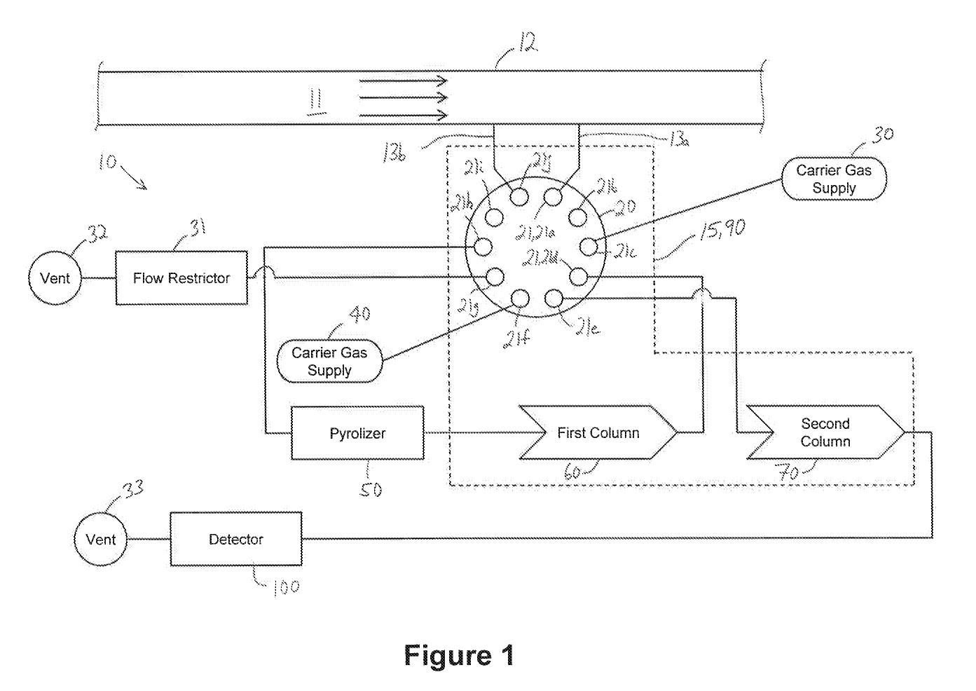

Referring now to FIG. 1, an embodiment of a system 10 for measuring and determining the total sulfur content in a fluid 11 (e.g., gas or liquid) flowing through a conduit 12 is shown. In general, the fluid 11 can be any gas, gaseous mixture, liquid, liquid mixture, or process stream for which determination of total sulfur content is desired. In this embodiment, the fluid 11 is flare gas and, thus, the conduit 12 can be the flare stack itself or other passage carrying flare gas upstream of the flare tip. Accordingly, the fluid 11 may also be referred to as a gas 11 or flare gas 11 in this exemplary embodiment, it being understood that the fluid 11 can be a liquid in other embodiments. The system 10 can be employed as part of a compliance program to satisfy environmental mandates and regulations relating to the total sulfur emitted from a refinery, chemical plant, factory, etc. Although the system 10 will be described in the context of determining the sulfur content in flare gas, embodiments of the system 10 can also be used to measure total sulfur content in numerous other process streams including fuel gas, Liquefied Petroleum Gas (LPG) and Natural Gas Liquids (NGL).

In this embodiment, the system 10 includes a gas chromatograph 15, a first carrier gas supply 30, a second carrier gas supply 40, a pyrolizer 50, and a detector 100. The gas chromatograph 15 includes a sample valve 20, a first gas chromatograph (GC) column 60, and a second GC column 70. In this embodiment, the gas chromatograph 15 is disposed in an oven 90, which carefully controls the temperature of the gasses passing therethrough. The gas chromatograph 15, and more specifically the sample valve 20, is coupled to the conduit 12 with a sample supply line 13a and a sample return line 13b, thereby enabling the periodic sampling and analysis of the gas 11 by the system 10. The carrier gas supplies 30, 40, the pyrolizer 50, the GC columns 60, 70, and the detector 100 are coupled to the valve 20, which selectively controls the periodic flow of a relatively small sample of the gas 11 through the system 10. The valve 20 also selectively controls the flow of a carrier gas 14 provided by the gas supplies 30, 40 through the system 10. In embodiments described herein, the carrier gas 14 provided by the gas supplies 30, 40 is hydrogen gas (H₂).

Referring still to FIG. 1, the sample valve 20 includes a plurality of ports 21 that can function as gas inlets and/or outlets. For purpose of clarity and to distinguish between the different ports 21 in the description below, the exemplary ten ports 21 are designated with reference numerals 21a-21j moving clockwise around the valve 20 in FIG. 1. The port 21a is in fluid communication with the sample supply line 13a, the port 21c is in fluid communication with the carrier gas supply 30, the port 21d is in fluid communication with the first GC column 60, the port 21e is in fluid communication with the second GC column 70, the port 21f is in fluid communication with the second carrier gas supply 40, and the port 21h is in fluid communication with the pyrolizer 50. In general, the valve 20 can be any valve, combination of valves, or device known in the art for providing selective fluid communication among a plurality of gas ports (e.g., the ports 21). Examples of sample or chromatograph valves that can be used for the valve 20 include Model 10, 11 or 50 Diaphragm-Plunger valves available from Siemens Corporation of Munich, Germany; Diaphragm-Plunger valves available from Emerson Electric Co. of St. Louis, Mo.; Continuous Performance Slider valves available from ABB Group of Zurich, Switzerland; 6, 10 and 12 port valves available from Yokogawa Electric Corp. of Tokyo, Japan, and 4, 6 port and 10 port valves available from Valco Instruments Co. Inc. of Houston, Tex. In general, fluid communication between the components of the system 10 and the valve ports 21 may be provided by any suitable means known in the art such as conduits, pipes, flow lines, or the like. Likewise, fluid communication between different components of the system 10 may be provided by any suitable means known in the art such as conduits, pipes, flow lines, or the like.

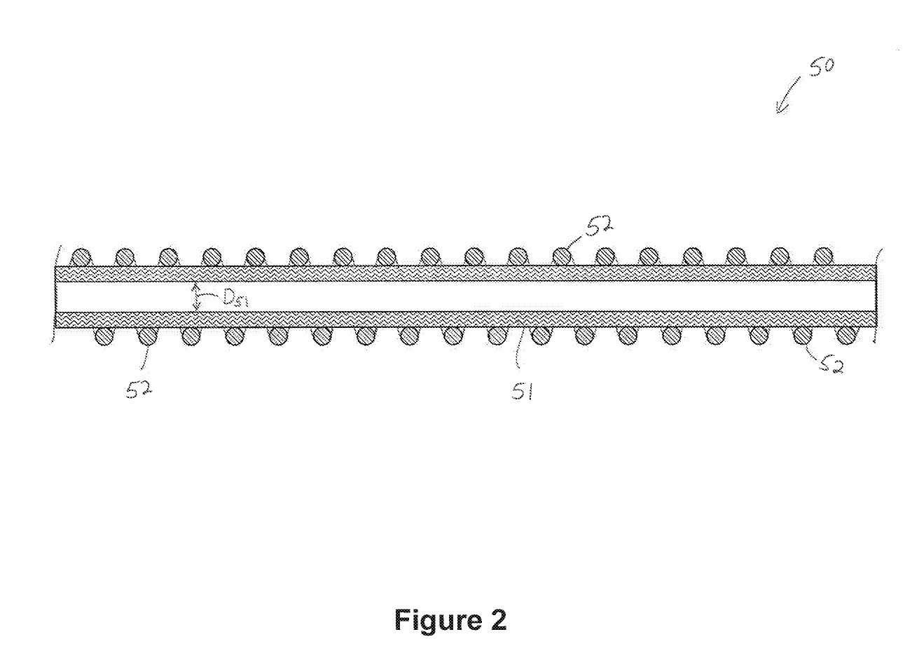

Referring still to FIG. 1, the pyrolizer 50 is coupled to and in fluid communication with the first GC column 60. As is known in the art, a pyrolizer, such as the pyrolizer 50, is a device or reactor that thermo-chemically decomposes organic compounds at elevated temperatures without the participation of oxygen. As best shown in FIG. 2, the pyrolizer 50 in this embodiment comprises a quartz flow line or tube 51 wrapped in one or more heating elements 52. As will be described in more detail below, during sampling and sulfur content determination operations, a sample of the gas 11 is carried through the tube 51 by the carrier gas 14. The heating elements 52 provide sufficient thermal energy to achieve pyrolysis of the sample of the flare gas 11 as it flows through the tube 51. In general, to achieve pyrolysis of the flare gas 11, the heating element(s) 52 heat the quartz tube 51, and thus, the sample of the flare gas 11 flowing therethrough, to a temperature between 950° and 1000° C. In general, the makeup of flare gas can vary over time and from plant to plant; however, flare gas typically comprises a mixture of gases including hydrocarbons (e.g., methane, ethane, ethylene, propane, propylene, butane, C4 olefins, pentane, C5 olefins, arenes, alkanes, alkenes, etc.), carbon monoxide, carbon dioxide, oxygen, nitrogen, organic sulfur compounds (e.g., COS, CS₂, etc.), and small amounts of other organic compounds. In the presence of excess hydrogen provided by the carrier gas 14, the pyrolizer 50 irreversibly and thermo-chemically transforms the sulfur compounds into hydrogen sulfide (H₂S). The hydrocarbons in the gas 11 that enter and pass through the pyrolizer 50 remain essentially unchanged and are not significantly affected by the pyrolizer 50. Thus, the pyrolizer 50 receives a mixture of the flare gas 11 and the hydrogen carrier gas 14, and produces a gaseous mixture including hydrocarbons, hydrogen sulfide (H₂S), and the carrier gas 14.

Unlike many conventional pyrolizers, the pyrolizer 50 in this embodiment is configured for use with the gas chromatograph 15. In general, gas chromatographs are particularly suited for the periodic processing of relatively small volumes of a sample gas (e.g., the gas 11). Accordingly, the pyrolizer 50 is configured for pyrolysis of relatively small sample volumes of the gas 11. The actual size of the sample volume will depend on a variety of factors including, without limitation, whether the sample is a liquid or a gas, the range of measurement (e.g., the ppm content of the compound of interest to be determined), and the type of detector used to determine the content of the compound of interest. For most applications, the sample volume is preferably in the range of 0.01 to 15.0 cc, more preferably, 0.05 to 5.0 cc, and even more preferably about 2 cc. In particular, the tube 51 of the pyrolizer 50 has a relatively small inner diameter D₅₁ that is preferably in the range of 0.5 to 2.0 mm. In this embodiment, the inner diameter D₅₁ of the quartz tube 51 is 1.0 mm.

Referring again to FIG. 1, the first GC column 60 of the gas chromatograph 15 is in fluid communication with the pyrolizer 50. As is known in the art, a gas chromatograph column, such as the GC column 60, is a device that separates different components in a fluid mixture. In particular, a “mobile” phase including a carrier fluid (e.g., the carrier gas 14) and the fluid mixture of compounds to be separated and analyzed (e.g., the flare gas 11) flows into the column. A “stationary” phase comprising a fluid or solid packing is disposed within the column, typically a glass or metal tubing. The mixture of compounds in the mobile phase interacts with the stationary phase, causing each compound to elute at a different time known as the retention time, thereby separating the different compounds to be analyzed.

In the first GC column 60, the mobile phase comprises the carrier gas 14 (i.e., hydrogen gas) from the first gas supply 30 and the mixture of gases output by the pyrolizer 50 (e.g., methane, hydrogen sulfide, etc.), and the stationary phase within the first GC column 60 comprises a graphitized carbon black type packing material such as Carboblack available from Restek Corporation of Bellefonte, Pa. or Carbopack™ available from Sigma-Aldrich® Co. LLC of St. Louis, Mo.

The gaseous compounds from the pyrolizer 50 interact with the stationary phase, thereby stripping the heavier hydrocarbons from the lighter hydrocarbons, the carrier gas 14, and hydrogen sulfide in the mobile phase. In particular, hydrocarbons having a carbon content greater than C₂⁺ (e.g., butane, pentane) interact with the stationary phase and are separated from the carrier gas 14, hydrocarbons having a carbon content less than C₃⁺ (e.g., methane, ethane), and hydrogen sulfide, which are allowed to freely pass through the first GC column 60.

Referring still to FIG. 1, as will be described in more detail below, the second GC column 70 is selectively placed in fluid communication with the first GC column 60 via the sample valve 20, thereby allowing the gaseous mixture output by the first GC column 60 to flow into the second GC column 70. The second GC column 70 is similar to the first GC column 60 previously described. However, in the second GC column 70, the mobile phase includes the carrier gas 14 (i.e., hydrogen gas) provided by the second gas supply 40 and the gaseous mixture output by the first GC column 60 (i.e., the carrier gas 14 from the first gas supply 30, hydrogen sulfide, and hydrocarbons having a carbon content less than C₃⁺), and the stationary phase within the second GC column 70 comprises a porous polymer type packing material such as HayeSep® available from Hutchison Hayes Separations Inc. of Houston, Tex. or Porapak™ available from Waters Corporation of Milford, Mass., or alternatively, a silica gel type packing material such as Res-Sil® available from Restek Corporation of Bellefonte, Pa., Porasil available from Waters Corporation of Milford, Mass., or Chromsil 310 available from Sigma-Aldrich® Co. LLC of St. Louis, Mo. The gases from the first GC column 60 interact with the stationary phase in the second GC column 70, thereby separating the remaining hydrocarbons from the carrier gas 14 and hydrogen sulfide in the mobile phase. In particular, hydrocarbons having a carbon content less than C₃⁺ (e.g., methane, ethane) are allowed to pass through the second GC column 70 before the hydrogen sulfide.

Referring still to FIG. 1, the detector 100 is in fluid communication with the second GC column 70. In general, the detector 100 is a device that measures the total sulfur content (ppm) in the sample of the gas 11 taken from the conduit 12. In embodiments described herein, the detector 100 is a thermal conductivity detector or a flame photometric detector. As is known in the art, a thermal conductivity detector is a detector that senses changes in the thermal conductivity of a carrier gas stream containing separated sample components and compares it to a reference flow of carrier gas. If the carrier gas stream contains a separated sample component, comparison of its thermal conductivity to the reference flow of the carrier gas can be used to determine the content of the separated compound. For example, hydrogen sulfide gas is a poor thermal conductor compared to hydrogen gas, and thus, a decrease in the thermal conductivity of a gaseous mixture of hydrogen sulfide and hydrogen as compared to the thermal conductivity of a reference flow of hydrogen gas indicates an increase in the hydrogen sulfide content. The quantitative differences in the thermal conductivities can be used to estimate the actual content of hydrogen sulfide in the gaseous mixture.

As is known in the art, a flame photometric detector uses a photomultiplier tube to detect and analyze the spectrum of light emitted by compounds as they as they combust and luminesce in a reducing flame. In particular, when compounds are burned in the flame, they emit photons of distinct wavelengths. Only those photons that are within the predetermined wavelength range of a filter pass through to the photomultiplier tube. Thus, using a filter that only allows passage of photons having a wavelength indicative of the specific compound of interest, only those photons resulting from the combustion of the specific compound of interest are received by the photomultiplier. For example, a 394 nm wavelength filter (blue on one side) allows detection of sulfur-containing compounds such as hydrogen sulfide. The photomultiplier converts the photons it “sees” (i.e., the photons that pass through the filter) to an analog signal, which is communicated to a data analysis system and processed to determine the content of the compound of interest.

The detector 100 measures the total hydrogen sulfide content (ppm) in the gaseous stream output from the second GC column 70. As previously described, any sulfur in the sample of the gas 11 taken from the conduit 12 is converted to hydrogen sulfide in the pyrolizer 50, the hydrogen sulfide output from the pyrolizer 50 is separated from the other hydrocarbon and organic compounds output from the pyrolizer 50 in the GC columns 60, 70, and the separated hydrogen sulfide is allowed to pass through the GC columns 60, 70 to the detector 100. Thus, the gaseous mixture entering the detector 100 is made up almost exclusively of hydrogen sulfide, lighter hydrocarbons (i.e., hydrocarbons having a carbon content less than C₃⁺), and the hydrogen carrier gas 14, and includes all of the sulfur present in the sample of the gas 11 taken from the conduit 12. The lighter hydrocarbons pass through the second GC column 70 before the hydrogen sulfide, and thus, pass through the detector 100 before the hydrogen sulfide, thereby enabling the detector 100 to distinguish the hydrogen sulfide from the lighter hydrocarbons. In embodiments where the detector 100 is a thermal conductivity detector, the detector 100 senses changes in the thermal conductivity of the gas mixture output from the second GC column 70 and compares it to the thermal conductivity of hydrogen gas (H₂) to determine the content of hydrogen sulfide in the sample of the gas 11. In embodiments where the detector 100 is a flame photometric detector, the detector 100 receives and analyzes the photons having a wavelength of 394 nm to determine the content of hydrogen sulfide in the sample of the gas 11. In such embodiments, the detector 100 is capable of detecting hydrogen sulfide at least in the range of 10 ppm to 100,000 ppm. It should be appreciated that the measured total content of hydrogen sulfide also represents the total content of sulfur as each hydrogen sulfide molecule includes one sulfur atom.

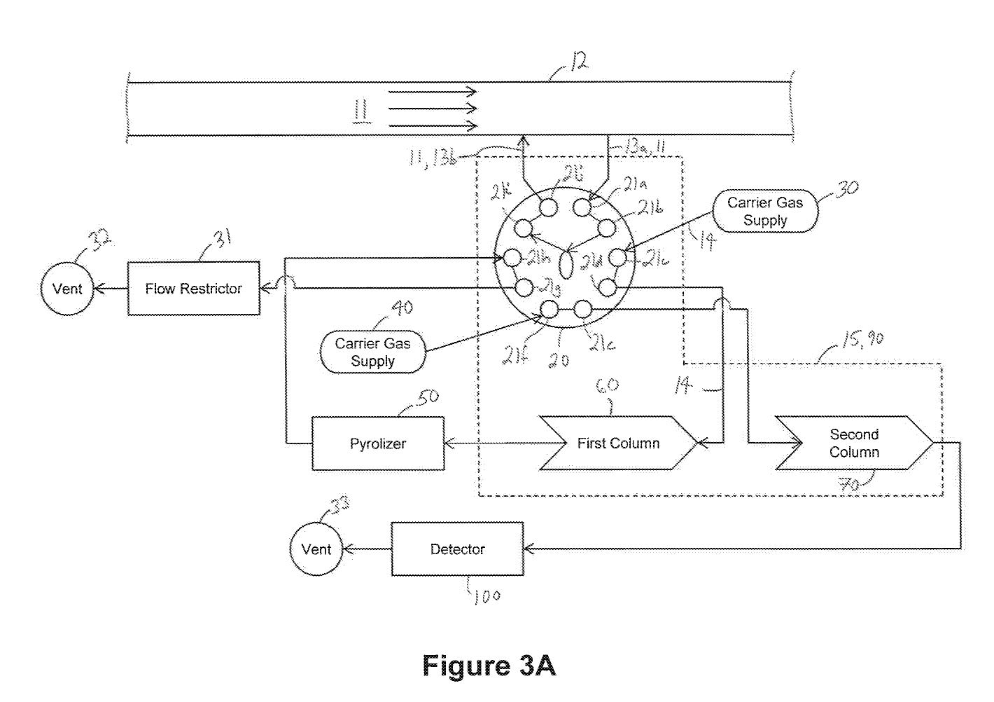

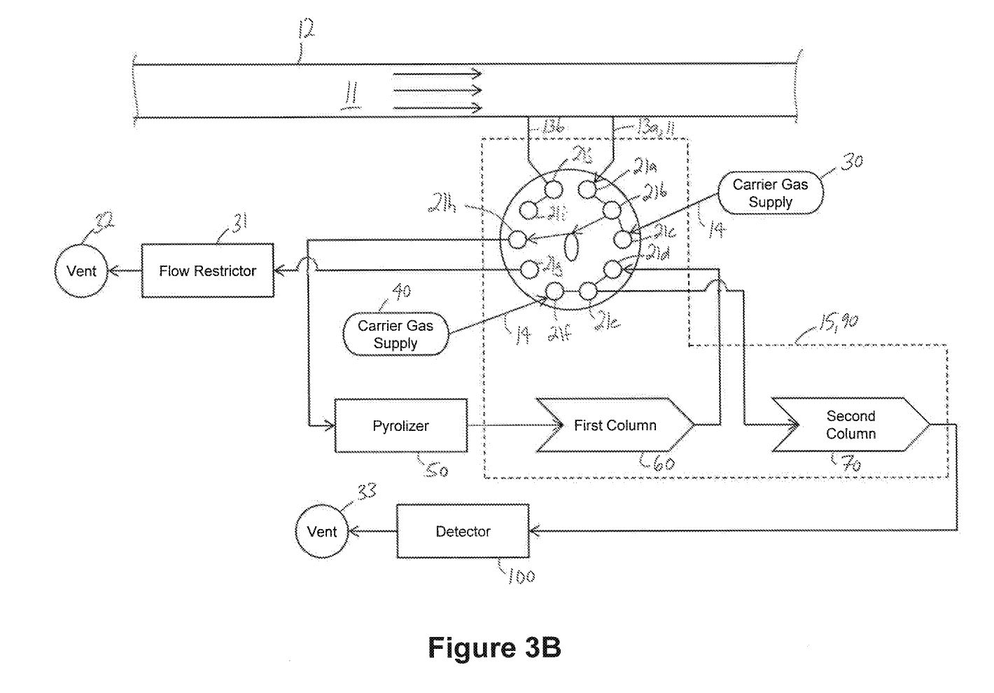

The sample valve 20 is configured to transition between a closed or backflush mode shown in FIG. 3A and an open or sampling mode shown in FIG. 3B. Acquisition of a sample of the flare gas 11 is prevented when the valve 20 is in the backflush mode, but is permitted when the valve 20 is in the sampling mode. Thus, by transitioning the valve 20 between the backflush mode and sampling mode, the system 10 periodically acquires and analyzes a sample of the flare gas 11. The valve 20 is preferably operated to periodically sample of a relatively small quantity of the flare gas 11 in the range of 1.0-5.0 cc, and more preferably about 2.0 cc.

Referring now to FIG. 3A, in the backflush mode shown in FIG. 3A, the valve 20 isolates the pyrolizer 50, the GC columns 60, 70, and the detector 100 from the gas 11 in the conduit 12, but allows the carrier gas 14 from the first gas supply 30 to backflush and “cleanse” the first GC column 60. In particular, the ports 21a, 21b, 21i, 21j are in fluid communication with each other, but not in fluid communication with any other ports 21. Thus, the gas 11 from the conduit 12 is allowed to enter the valve 20 via the supply line 13a and the port 21a, but is routed back into the conduit 12 via the ports 21b, 21i, 21j and the return line 13b. Further, the ports 21c, 21d are in fluid communication with each other, and the ports 21g, 21h are in fluid communication with each other. Thus, the carrier gas 14 from the first carrier gas supply 30 flows through the ports 21c, 21d, then through the first GC column 60 and the pyrolizer 50 into the port 21g, thereby backflushing the first GC column 60 to remove the heavier hydrocarbons and organic compounds that may have been captured therein. The carrier gas 14 that has backflushed the first GC column 60, as well as any other compounds picked up by the carrier gas 14, flow through the ports 21g, 21h, a flow restrictor 31 that maintains back pressure in the pyrolizer 50 and the first GC column 60, and a vent 32. The ports 21e, 21f are in fluid communication, and thus, the carrier gas 14 from the second carrier gas supply 40 is allowed to flow through the ports 21e, 21f, the second GC column 70, and the detector 100 to the vent 33.

Referring now to FIG. 3B, in the sampling mode, the valve 20 allows the gas 11 to flow from the conduit 12 through the pyrolizer 50, the first GC column 60, the second GC column 70, and the detector 100. In particular, the ports 21a, 21b, 21c, 21h are in direct fluid communication with each other, and in indirect fluid communication with the ports 21d, 21e, 21f via the pyrolizer 50 and the first GC column 60. Thus, the gas 11 from the conduit 12 is allowed to enter the valve 20 via the supply line 13a and flow through the port 21a to the port 21b where it mixes with the carrier gas 14 from the first gas supply 30. The carrier gas 14 then carries the gas 11 from the port 21b through the port 21h, the pyrolizer 50, the first GC column 60 and the port 21e to the port 21f where it mixes with the carrier gas 14 from the second gas supply 40. The carrier gas 14 then carries the gas 11 from the port 21f through the second GC column 70 and the detector 100 to the vent 33. The ports 21i, 21j are in fluid communication with each other, but not in fluid communication with any other ports 21, and the port 21g is not in fluid communication with any other ports 21.

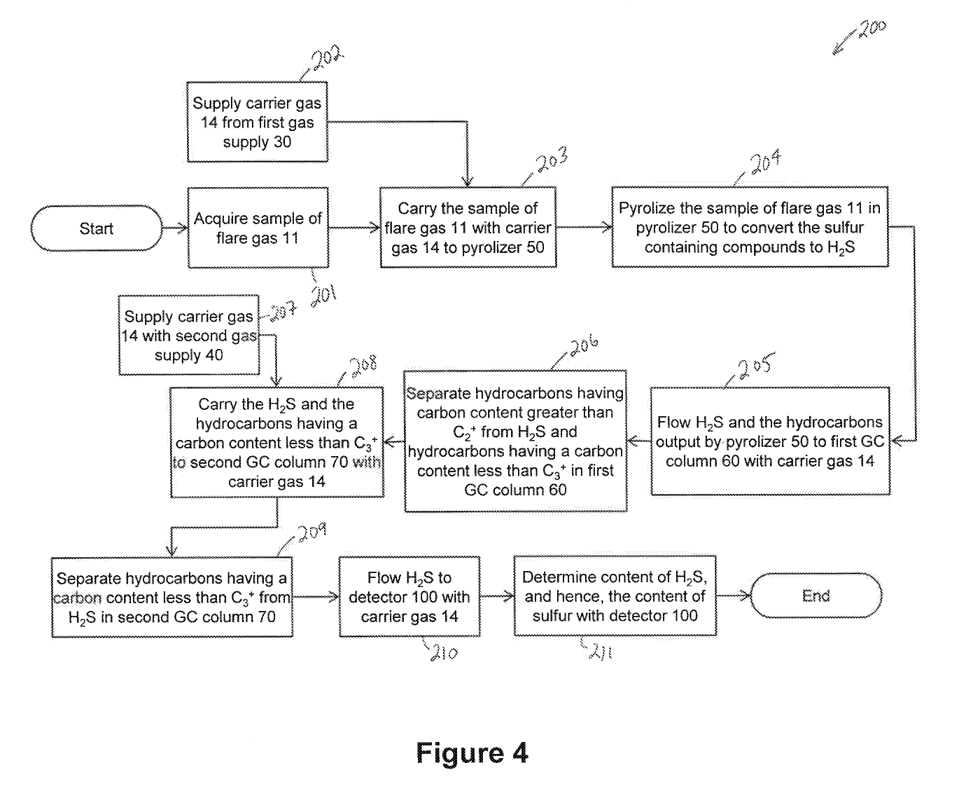

Referring now to FIG. 4, an overview of an embodiment of a method 200 for determining the sulfur content of the flare gas 11 using the system 10 with the valve 20 in the sampling mode (FIG. 3B) is schematically shown. Beginning in step 201, a relatively small sample of the flare gas 11 (e.g., 0.5-5.0 cc) is acquired from the conduit 12. The sample flows into the valve 20 via the supply line 13a, where it is picked up and carried by the carrier gas 14 from the first gas supply 30 to the pyrolizer 50 as shown in steps 202 and 203. Next, in step 204, the sample of the flare gas 11 undergoes pyrolysis in the pyrolizer 50 in the presence of excess hydrogen provided by the carrier gas 14, thereby decomposing the sulfur containing compounds in the flare gas 11 into hydrogen sulfide.

Moving now to step 205, the gaseous products from the pyrolizer 50 are flowed to the first GC column 60. In step 206, the hydrocarbons having a carbon content greater than C₂⁺ are separated from the hydrogen sulfide and the hydrocarbons having a carbon content less than C₃⁺ in the first GC column 60. The hydrogen sulfide and hydrocarbons having a carbon content less than C₃⁺ pass through the first GC column 60, and are picked up and carried by the carrier gas 14 from the second gas supply 40 to the second GC column 70 as shown in steps 207 and 208. Next, in step 209, the hydrocarbons having a carbon content less than C₃⁺ are separated from the hydrogen sulfide in the second GC column 70 as previously described. The carrier gas 14, the hydrocarbons having a carbon content less than C₃⁺, and the hydrogen sulfide (with the hydrogen sulfide lagging behind the hydrocarbons having a carbon content less than C₃⁺) pass through the second GC column 70 and into the detector 100 in step 210, which determines the content of the hydrogen sulfide, and hence the content of sulfur, in step 211.

Although the system 10 and the method 200 have been described with regard to determining the total sulfur content in flare gas, it should be appreciated that the system 10 and the method 200 can also be used to determine the total sulfur content in numerous types of fluid streams (liquids or gases) containing sulfur compounds. For example, the system 10 and the method 200 can be used to determine the total sulfur content in fuel gas, Liquefied Petroleum Gas (LPG), Natural Gas Liquids (NGL), etc.

In the embodiment of the system 10 shown in FIG. 1, the gas chromatograph 15 includes one sample valve 20 and two GC columns 60, 70. However, embodiments of systems described herein for measuring and determining the total sulfur content in a fluid stream can include more complex gas chromatographs having additional valves, columns, etc. For example, the pyrolizer 50 and the detector 100 can be used with a gas chromatograph that includes a second valve for foreflushing and venting compounds lighter than hydrogen sulfide (e.g., hydrocarbons having a carbon content less than C₃⁺).

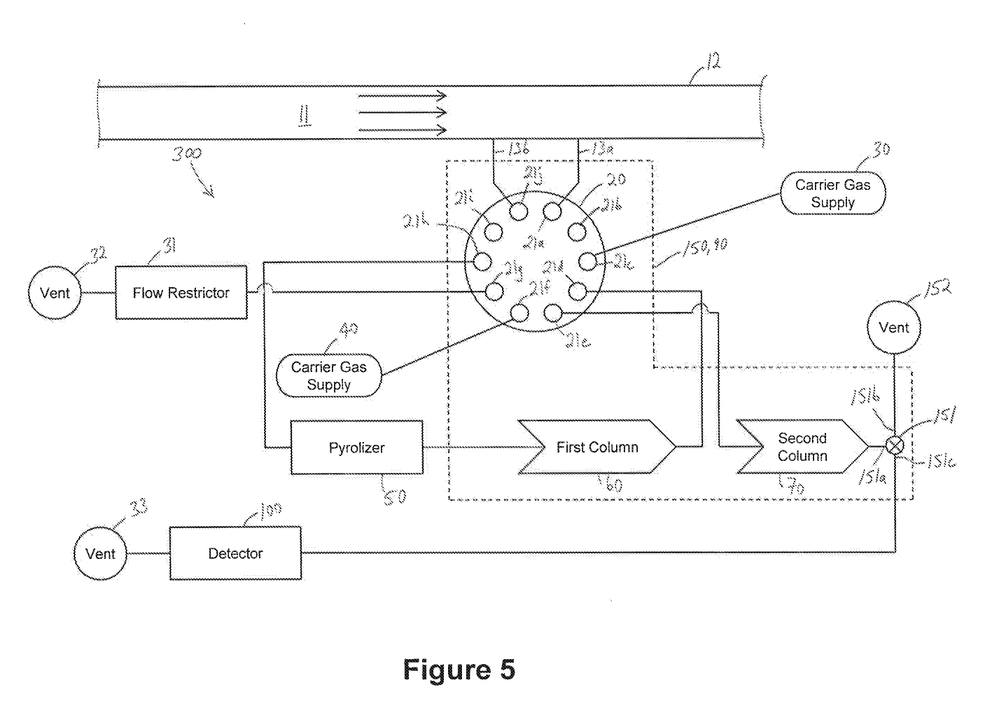

Referring now to FIG. 5, an embodiment of a system 300 for measuring and determining the total sulfur content in the fluid 11 flowing through the conduit 12. In this exemplary embodiment, the fluid 11 is flare gas, although the system 300 can be employed to measure total sulfur content in numerous other process streams including fuel gas, Liquified Petroleum Gas (LPG) and Natural Gas Liquids (NGL). The system 300 is substantially the same as the system 10 previously described except that a second valve is provided in the gas chromatograph to fore flush and vent compounds lighter than hydrogen sulfide (e.g., hydrocarbons having a carbon content less than C₃⁺) upstream of the detector. In particular, the system 300 includes a gas chromatograph 150, a first carrier gas supply 30, a second carrier gas supply 40, a pyrolizer 50, and a detector 100. The gas supplies 30, 40, the pyrolizer 50, and the detector 100 are each as previously described. The gas chromatograph 150 includes a sample valve 20, a first gas chromatograph (GC) column 60, and a second GC column 70, each as previously described. However, in this embodiment, the gas chromatograph 150 also includes a second valve 151 between the second GC column 70 and the detector 100. The valve 151 has an inlet 151a in fluid communication with the second GC column 70, a first outlet 151b in fluid communication with a vent 152, and a second outlet 151c in fluid communication with the detector 100. The valve 151 is actuated between a first position with the inlet 151a and the outlet 151b in fluid communication and a second position with the inlet 151a and the outlet 151c in fluid communication. Thus, when the valve 151 is in the first position, fluids output from the second GC column 70 pass through the inlet 151a, the outlet 151b, and the vent 152 to the outside environment, and when the valve 151 is in the second position, fluids output from the second GC column 70 pass through the inlet 151a and the outlet 151c to the detector 100. In general, the valve 151 can be any suitable valve known in the art for providing selective fluid communication between an inlet and multiple outlets.

Referring still to FIG. 5, the system 300 is operated in the same manner as the system 10 previously described except that the valve 151 is disposed in the first position as lighter hydrocarbons (i.e., hydrocarbons having a carbon content less than C₃⁺) exit through the second GC column 70, and disposed in the second position as hydrogen sulfide exits the second GC column 70. As previously described, lighter hydrocarbons (i.e., hydrocarbons having a carbon content less than C₃⁺) pass through the second GC column 70 before the hydrogen sulfide. Thus, with the valve 151 in the first position prior to hydrogen sulfide exiting the second GC column 70, the lighter hydrocarbons exiting the second GC column 70 are communicated to the vent 152 and do not flow to the detector 100; and with the valve 151 in the second position before or as hydrogen sulfide begins to exit the second GC column 70, the hydrogen sulfide is communicated to the detector 100. Since the lighter hydrocarbons and the hydrogen sulfide pass through the the second GC column 70 at different rates, the valve 151 can be used to foreflushing the lighter hydrocarbons to the vent 152, thereby bypassing the detector 100, while directing the hydrogen sulfide to the detector 100.

While preferred embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

What is claimed is:

1. A system for determining the content of sulfur in a first fluid mixture including one or more sulfur compounds, the system comprising:
a gas chromatograph including a sample valve configured to receive the first fluid mixture, a first column coupled to the sample valve, and a second column coupled to the sample valve;
a pyrolizer coupled to the sample valve, wherein the pyrolizer is configured to subject the first fluid mixture to pyrolysis to produce a second fluid mixture that includes hydrogen sulfide;
wherein the first column is configured to receive the second fluid mixture from the pyrolizer and separate at least a first constituent of the second fluid mixture from the hydrogen sulfide in the second fluid mixture and output a third fluid mixture including the hydrogen sulfide;
wherein the second column is configured to receive the third fluid mixture from the first column and separate at least a second constituent in the third fluid mixture from the hydrogen sulfide in the third fluid mixture and output a fourth fluid mixture including the hydrogen sulfide; and
a detector in fluid communication with the second column, wherein the detector is configured to receive the fourth fluid mixture from the second column and determine the content of hydrogen sulfide in the fourth fluid mixture.

2. The system of claim 1, wherein the first fluid mixture is flare gas including a plurality of hydrocarbons and the one or more sulfur compounds.

3. The system of claim 1, further comprising:
a first carrier gas supply coupled to the sample valve and configured to supply a first carrier gas;
wherein the first carrier gas is configured to mix with the first fluid mixture and carry the first fluid mixture to the pyrolizer.

4. The system of claim 3, wherein the first carrier gas is hydrogen gas.

5. The system of claim 3, further comprising:
a second carrier gas supply coupled to the sample valve and configured to supply a second carrier gas;
wherein the second carrier gas is configured to mix with the third fluid mixture and carry the third fluid mixture to the second column.

6. The system of claim 5, wherein the first carrier gas and the second carrier gas are both hydrogen gas.

7. The system of claim 2, wherein the first column is configured to separate a first portion of hydrocarbons from the second fluid mixture, and wherein the second column is configured to separate a second portion of hydrocarbons from the third fluid mixture.

8. The system of claim 1, wherein the first column and the second column are both configured to allow hydrogen sulfide to flow therethrough.

9. The system of claim 1, wherein the detector is a thermal conductivity detector or a flame photometric detector.

10. The system of claim 1, wherein the pyrolizer comprises a tube and one or more heating elements disposed about the tube, wherein the tube has an inner diameter of 0.5 to 2.0 mm.

11. A method for determining the content of sulfur in a gas mixture including hydrocarbons and sulfur compounds, the method comprising:
(a) acquiring a sample of the gas mixture;
(b) subjecting the sample to pyrolysis in a pyrolizer;
(c) converting the sulfur compounds to hydrogen sulfide during (b);
(d) separating high-weight hydrocarbons from the hydrogen sulfide with a first column of a gas chromatograph after (b);
(e) flowing the hydrogen sulfide to a detector after (d);
(f) determining the hydrogen sulfide content with the detector.

12. The method of claim 11, wherein (d) further comprises:
separating low-weight hydrocarbons from the hydrogen sulfide with a second column of the gas chromatograph after (b).

13. The method of claim 12, wherein the gas mixture is flare gas, the high weight hydrocarbons are hydrocarbons having a carbon content greater than C₂⁺, and the low weight hydrocarbons are hydrocarbons having a carbon content less than C₃⁺.

14. The method of claim 11, further comprising:
carrying the gas mixture to the pyrolizer with a first carrier gas.

15. The method of claim 14, further comprising:
carrying the hydrogen sulfide to the detector with a second carrier gas.

16. The method of claim 15, wherein the first carrier gas and the second carrier gas are both hydrogen gas.

17. The method of claim 11, wherein (a) comprises acquiring a 0.05 to 5.0 cc sample of the gas mixture.

18. The method of claim 11, wherein (a) comprises transitioning a sample valve between a backflush mode to a sampling mode, wherein the first column and the pyrolizer are backflushed in the backflush mode and the sample is acquired in the sampling mode.

19. A method for determining the content of sulfur in flare gas including hydrocarbons and sulfur compounds, the method comprising:
(a) periodically acquiring a sample of flare gas, wherein each sample has a volume of 0.5-5.0 cc;
(b) converting the sulfur compounds in each sample to hydrogen sulfide;
(c) separating the hydrocarbons from the hydrogen sulfide in each sample;
(d) determining the hydrogen sulfide content in each sample with a detector after (c).

20. The method of claim 19, wherein (c) comprises:
(c1) separating hydrocarbons having a carbon content greater than C₂⁺ from the hydrogen sulfide with a first column of a gas chromatograph; and
(c2) separating hydrocarbons having a carbon content less than C₃⁺ from the hydrocarbons with a second column of the gas chromatograph in fluid communication with the first column.

21. The method of claim 20, wherein (a) comprises:
periodically transitioning a sample valve between a backflush mode and a sampling mode.

22. The method of claim 21, wherein the first column is backflushed with hydrogen gas in the backflush mode, and a sample of flare gas is acquired in the sampling mode.

23. The method of claim 21, wherein the detector is a thermal conductivity detector or a flame photometric detector.

24. A system for determining the content of sulfur in a fluid mixture including one or more sulfur compounds, the system comprising:
a gas chromatograph including a sample valve, a first column coupled to the sample valve, and a second column coupled to the sample valve;
a pyrolizer coupled to the sample valve; and
a hydrogen sulfide detector in fluid communication with the second column.

25. The system of claim 24, wherein the fluid mixture is flare gas including a plurality of hydrocarbons and the one or more sulfur compounds.

26. The system of claim 24, further comprising a first carrier gas supply coupled to the sample valve.

27. The system of claim 26, further comprising a second carrier gas supply coupled to the sample valve.

28. The system of claim 27, wherein the first carrier gas supply and the second carrier gas supply are each hydrogen gas supplies.

29. The system of claim 24, wherein the detector is a thermal conductivity detector or a flame photometric detector.

30. The system of claim 24, wherein the pyrolizer comprises a tube and one or more heating elements disposed about the tube, wherein the tube has an inner diameter of 0.5 to 2.0 mm.
